(19) United States
(12) Patent Application Publication
(10) Pub. No.: US 2010/0090165 A1
(43) Pub. Date: Apr. 15, 2010

(54) PROCESS AND APPARATUS FOR TREATMENT OF ORGANIC SOLVENTS

(75) Inventors: Graham John Bratton, Kent (GB); Colin Danny Murton, Hampshire (GB)

Correspondence Address: SCHWEGMAN, LUNDBERG & WOESSNER, P.A., P.O. BOX 2938, MINNEAPOLIS, MN, 55402, US

(73) Assignee: PHOENIX IPR LIMITED, Kent (GB)

(21) Appl. No.: 12/530,738

(22) PCT Filed: Mar. 13, 2008
(86) PCT No.: PCT/GB08/50175

§ 371 Date: Sep. 10, 2009

(30) Foreign Application Priority Data
Mar. 16, 2007 (GB) 0705079.2

(51) Int. Cl. B01F 1/00; B01D 35/18

(52) U.S. Cl. 252/364; 210/175

(57) ABSTRACT

A method is provided for separating water from an organic solvent which comprises: passing the solvent through at least one conduit within a porous ceramic with a zeolite membrane formed on the internal surface of the conduit; recovering solvent of reduced water content from the conduit; and recovering water which has passed via the membrane through the ceramic to the exterior thereof. The velocity at which the solvent is passed through the conduit induces turbulent flow for scouring solids from the surface of the membrane and reducing or preventing concentration of the organic solvent on the membrane surface e.g. at 1-6 m/s The invention also provides a method of separating water from an organic solvent which comprises: supplying the solvent to first, second and third tanks; circulating solvent between the first tank and zeolite membranes to separate water therefrom; recovering separated water from the membranes; supplying fresh solvent to the second tank; recovering solvent separated of water from the third tank in heat-exchange relationship with solvent supplied to the second tank; and on completion of water separation initiating at least a first new processing cycle in which recovery is from the first tank, circulation is from the second tank and supply is to the third tank. On completion of said first new processing cycle at least a second cycle may be initiated in which supply is to the first tank, recovery is from the second tank and circulation is from the third tank. Apparatus is also provided for separating first and second fluids, comprising: a multiplicity of tubular porous ceramic monoliths having tubular conduits formed within the monolith with a zeolite membrane formed on the internal surface of each of the conduits; first and second support plates each formed with a multiplicity of holes for receiving the ends of the monoliths for supporting said monoliths in spaced parallel relationship, the holes where they open to outer faces of the support plates being formed with counterbores; O-rings in the counterbores for supporting the monoliths in the apertures each at a small clearance from its respective hole; first and second cover plates attached to the first and second support plates and formed with holes corresponding to the holes in the support plate leading to enlarged inwardly facing regions in which ends of the monoliths are received, attachment of the cover plate compressing the O-rings to seal against the monolith; and a housing having a flow passage in which the first and second support Phoenix,002-PCT26 plates are welded; wherein the support plates have outer surfaces machined flat after the support plates have been welded in position.

### FIELD OF THE INVENTION

This invention relates to methods and apparatus for separating water from organic solvents using zeolite membranes.

### BACKGROUND TO THE INVENTION

U.S. Pat. No. 5,362,522 (Bratton et al., the disclosure of which is incorporated herein by reference) is concerned with the production of zeolite membranes and discloses that although there had at the time been extensive research in the field, there had been no previous disclosure by which a zeolite membrane having a continuous layer of zeolite directly connected to the surface of a support could be prepared. There was therefore provided a process for the production of a membrane comprising a film of a crystalline material which is a molecular sieve with a crystal structure made up of tetrahedra joined together through oxygen atoms to produce an extended network with conduits of molecular dimensions, said film being formed over the pores of a porous support. The process comprised (a) immersing at least one surface of said porous support in a mixture including a synthesis gel which was capable of crystallizing to produce the crystalline material; (b) inducing crystallization of said gel so that said material crystallized on the support; (c) removing the support having a film of said crystalline material from the remaining mixture: and (d) repeating these steps one or more times to obtain a membrane in which the material was crystallized directly from the support and bonded directly to the support.

U.S. Pat. No. 5,554,286 (Okamoto et al., Mitsui; see also the equivalent EP-A-0659469 now withdrawn; the disclosure of these specifications is incorporated by reference) discloses a membrane with sufficient permeation rates and separating factors for liquid mixture separation to be used in pervaporation or vapor permeation. It comprised a porous support, seed crystals held on a surface of said support, said seed crystals having an average particle size of 1-5 μm and being held on the surface of the support in an amount of 0.5-5.0 mg/cm², and an A-type zeolite film (e.g. zeolite A4) deposited on said porous support after the seed crystals are held thereon. A preferred porous support is Al₂O₃—SiO₂ ceramic material containing Al₂O₃30-80 wt % which has an average pore diameter of 0.1-2 μm, and a porosity of 30-50%. No restrictions are imposed 30on the shape of the porous support. However, that used for the pervaporation or vapor permeation should be in the form of pipe 20-100 cm long, about 10-30 mm in outside diameter, and 0.2 mm to several mm in thickness. It could also be in the form of cylinder, 20-100 cm long, 30-100 mm in outside diameter, and 0.2 mm to several mm in thickness, having a plurality of holes or conduits 2-12 mm inside diameter arranged parallel in the axial direction. In an experiment there was used a tubular porous alumina support “Multipoaron” made by Mitsui Kensaku-Toishi Co., Ltd. and measuring 1 cm in outside diameter, 20 cm long, 1 mm thick, 1 μm in pore diameter, and 40% porosity. The support was brush coated with zeolite 4A seed crystals of particle size <345 μm (200 mesh) followed by hydrothermal synthesis to form a membrane which was used for separation of water-ethanol mixture by the pervaporation method or vapor permeation.

U.S. Pat. No. 6,635,594 (Bratton et al., the disclosure of which is incorporated herein by reference, see also WO 00/21628) is concerned with the pre-treatment of tubular conduits to promote membrane formation. In particular, it discloses a method of treating a porous substrate which has tubular conduits formed within it, which method comprises mixing together zeolite particles of different size distributions having a diameter of between 20 μm and 0.1 μm to form a suspension of the particles, passing the suspension of zeolite particles down through the tubular conduits and out through the walls of the tubular conduits so as to deposit a layer of zeolite particles on the inner surface of the tubular conduits. In an embodiment, pulverized zeolite particles are mixed with unground particles to obtain the mixture of zeolite particles used for pre-treatment. In order to bring about deposition periods of flow of the suspension along the tubular conduits alternate with periods of cross-flow in which suspending liquid passes through the walls of the tubular conduits.

U.S. Pat. No. 5,935,440 (Bratton et al., the disclosure of which is incorporated herein by reference) relates to zeolitic membranes. It is concerned with the problem of avoiding small membrane defects or pinholes which can have a marked deleterious effect on the performance of a membrane and can render it of little value for many purposes. This is because in many separation operations the effect of defects is essentially to provide a route through which the unseparated products can pass. It further explains that some existing methods claim that a defect free membrane is obtained on a laboratory scale, but that attempts to provide a substantially defect free membrane on a larger scale have proved unsuccessful. The disclosed solution is to treat a membrane comprising a film of a crystalline zeo-type material on a porous support of ceramics or other material and formed by any method, for example by crystallisation from a gel or solution, by plasma deposition or by any other method such as electro deposition of crystals on conducting substrates e.g. as described in DE 4109037 with a silicic acid and/or polysilicic acid or a mixture of silicic and/or poysilicic acids. By silicic acid is meant monosilicic, low, medium and high molecular weight polysilicic acids and mixtures thereof.

Methods of making silicic acids are described in GB Patent Application 2269377 (Bratton et al., the disclosure of which is incorporated herein by reference). A preferred method is by acidification of a sodium silicate solution followed by separation of the silicic acid by phase separation using an organic solvent such as tetrahydrofuran. The organic phase can then be dried and anhydrous silicic acid separated e.g. by addition of n-butanol to obtain a substantially anhydrous solution of silicic acid. The degree of polymerisation of the silicic acid depends on the actual conditions used e.g. the time the sodium silicate solution is in contact with the acid before addition of the organic solvent, temperature etc. The silicic acid used preferably has an average molecular weight in the range of 96 to 10,000 and more preferably of 96 to 3220. The structure of the polysilicic acid may be linear and/or cyclic, including fused cyclic, chains of Si—O— groups such as ones in cube or fused cube arrangements with at least one e.g. 1-10 such as 2-6 fused cubes in a linear or non linear spatial distribution. Each cube has a silicon atom at each corner or bridge and an oxygen atom between each silicon atom, and one hydroxyl group on each silicon corner atom. The cubes may be joined together by at least one Si—O—Si bond but are preferably fused together with a common plane of a ring of 4 —Si—O— groups. Generally the polysilicic acids may have the formula(SiO)₄ₐ(SiO)_{4b}(OH)_{c}, where a is 1, b is 0-6 e.g. 1-4 and c is an integer so that spare valencies on silicon atoms can be satisfied and is usually such that c/2 is an integer of 4-8 especially 4 or 5. A preferred polysilicic acid is one of molecular weight 792, with 2 fused cubes of SiO groups and 8 corner OH groups and is of formula S₁₂O₂₀(OH)₈. The polysilicic acids are stable e.g. for up to 6 months, in the absence of acids or bases and water, and are usually stabilised in polar organic solvent concentrates by the presence of the solvent which may solvate them.

### SUMMARY OF THE INVENTION

In one aspect the invention provides a method for separating water from an organic solvent which comprises:

passing the solvent through at least one conduit within a porous ceramic with a zeolite membrane formed on the internal surface of the conduit;

recovering solvent of reduced water content from the conduit; and

recovering water which has passed via the membrane through the ceramic to the exterior thereof;

wherein the velocity at which the solvent is passed through the conduit induces turbulent flow for scouring contaminants from the surface of the membrane and/or reducing or preventing concentration of the organic solvent on the membrane surface.

In another aspect, the invention provides a method for separating water from an organic solvent which comprises:

supplying the solvent to first, second and third tanks;

circulating solvent between the first tank and zeolite membranes to separate water therefrom;

recovering separated water from the membranes;

supplying fresh solvent to the second tank;

recovering solvent separated of water from the third tank in heat-exchange relationship with solvent supplied to the second tank; and

on completion of water separation initiating at least a first new processing cycle in which recovery is from the first tank, circulation is from the second tank and supply is to the third tank. Usually, on completion of said first new processing cycle at least a second cycle is initiated in which supply is to the first tank, recovery is from the second tank and circulation is from the third tank, the several steps then continuing cyclically on a multi feed tank rapid batch basis. The functionality of the first, second and third tanks may be changed as required from cycle to cycle by switching control valves in the various pipelines of the apparatus used to carry out the above method.

The invention further provides apparatus for separating water from an organic solvent which comprises:

a solvent supply line;

first, second and third tanks;

a membrane module containing zeolite membranes for effecting separation of water from the organic solvent;

a pump and lines for circulating solvent from one of the tanks under pressure through the membrane module;

a line at reduced pressure for recovering separated water from the membrane module;

valve means for switching each of the tanks between receiving, circulation and emptying modes; and

a heat exchanger for exchanging heat between solvent entering one of the tanks and treated solvent being drained from another of the tanks.

In a further aspect the invention provides apparatus for separating first and second fluids, comprising:

a multiplicity of tubular porous ceramic monoliths having tubular conduits formed within the monolith with a zeolite membrane formed on the internal surface of each of the conduits;

first and second support plates each formed with a multiplicity of holes for receiving the ends of the monoliths for supporting said monoliths in spaced parallel relationship, the holes where they open to outer faces of the support plates being formed with counterbores;

O-rings in the counterbores for supporting the monoliths in the apertures each at a small clearance from its respective hole;

first and second cover plates attached to the first and second support plates and formed with holes corresponding to the holes in the support plate leading to enlarged inwardly facing regions in which ends of the monoliths are received, attachment of the cover plate compressing the O-rings to seal against the monolith; and

a housing having a flow passage in which the first and second support plates are welded;

wherein the support plates have outer surfaces machined flat after the support plates have been welded in position. Welding and subsequent drilling of the holes and machining of the counterbores after the support plates have been machined flat facilitates the formation of effective seals to all the monoliths with a significantly reduced tendency to leaks.

### BRIEF DESCRIPTION OF THE DRAWINGS

How the invention may be put into effect will now be described, by way of example only, with reference to the accompanying drawings in which:

FIG. 1 is a schematic of some of the principal features of a solvent treatment plant;

FIG. 2 is a diagrammatic perspective view of a porous monolith;

FIG. 3a is a front view of a treatment module for holding supports or monoliths e.g. as shown in FIG. 2, FIG. 3b is a view in longitudinal section on the line shown in FIG. 3a, FIG. 3c is a partial elevation of a monolith support plate forming part of the module of FIGS. 3a and 3b, FIG. 3d is a section of part of the monolith support plate of FIG. 3c and FIG. 3e is a view of a one end of a monolith fixed into support and cover plates which are shown in section.

FIG. 4 provides a pair of images of a practical embodiment of a treatment module, the upper image having a membrane cover plate in place and the lower image having a membrane cover plate removed to reveal monoliths, some of which appear partly inserted.

### DETAILED DESCRIPTION OF PREFERRED EMBODIMENT

In an embodiment, membranes are formed by a continuous zeolite film supported on a porous alumina substrate e.g. using any of the above mentioned processes. Being totally zeolitic the membrane exhibits excellent solvent resistance. Solutions can be dried and concentrated down from any water level to below 0.1% water and azeotropes are easily broken. High temperature resistance of this membrane enables application at higher temperatures yielding higher permeate fluxes and reduced membrane area or shorter drying times. Due to the high membrane selectivity the permeate produced consists of high purity water which can be recycled or discharged without further treatment.

The present membranes are useful inter alia for membrane pervaporation systems for drying bio-ethanol to produce the new greener fuel-bio-ethanol. The advantages of this fuel have already been widely recognised due to its many attributes and positive impacts on air quality by:
Cleaner combustion
Reduced CO₂ emission and other air pollutants
Production from renewable resources—agricultural crops
Employment in low income/agricultural based economies
Ability to mix with gasoline and be used as a fuel extender
Incorporation up to 30% should be possible in all present vehicle engines without modification
   The present technology can be used to dry ethanol e.g. from 96% to 99.8%. Additionally the technology is commercially attractive for drying a wide range of solvents in the pharmaceutical and fine chemical industries.

The membrane forming process which may be used includes syntheses of zeo-type materials in the presence of a porous support or monolith. Typical zeolites which can be used in the present invention include membrane-forming materials e.g. zeolites 3A, 4A, 5A, 13X, X, Y, ZSM5, MAPOs, SAPOs, AlPO's, Silicalite β, θ, pillared clays etc, A zeolite membrane of over a 20 μm pore size is very weak and will not withstand high pressures during use. A small pore size will restrict the escape of the water and reduce permeability and hence performance. The ideal pore size therefore for α-alumina is 3-12 μm with zeolite 4A being preferred for many applications on account of its ˜4.2 Å pore size which enables it effectively to separate water from methanol or ethanol. zeolite membranes can concentrate solvents to excess of 99.95% purity; therefore, drying ethanol from 96% to 99.8% is well within the technology's capabilities.

In one embodiment the membrane structure is as disclosed in International patent publication WO 00/20105 (Bratton et al., the disclosure of which is incorporated herein by reference). That specification discloses a particular arrangement of tubular membranes gave unexpectedly superior results for zeolite membranes in pervaporation over what would have been expected, and comprises a tubular porous ceramic monolith having at least four tubular conduits formed within the monolith with a zeolite membrane formed on the internal surface of the conduits the zeolite membranes having an internal diameter of 5 to 9 mm preferably 6.4 mm and the ceramic monolith having an outer diameter of 20 to 25 mm, preferably 20 mm.

In another embodiment, the membrane structure comprises a tubular porous ceramic monolith having tubular conduits each having an internal diameter of 5 to 9 mm formed within the monolith with a zeolite membrane formed on the internal surface of each of the conduits, wherein either (a) there are four conduits and the monolith is longer than 600 mm or (b) there are five or more conduits e.g. 7, 19 or 37, although numbers other than these may also be used. Other possibilities for numbers of conduits are available e.g. 6, 8 18, 20. Subject to what has been said above about four conduit monoliths, it will be understood that the monoliths do not have to have any specific length, and the 600 and 1200 mm lengths mentioned herein are convenient examples only. Diameters of conduits may for example be about any of 3, 4, 4.5, 5, 5.5, 6, 6.5, 7, 7.5, 8, 8.5 and 9 mm or above

In embodiments there are 7 or 19 conduits, the wall thickness between conduits is about 2 mm, the wall thickness between the conduits and the outer surface of the monolith is about 4 mm, the monolith is of length about 600 mm or 1200 mm and has an outer diameter of 20 to 50 mm. Typically the zeolite membranes each have a diameter of about 6.4 millimetres. The support may be of sintered ceramic powder e.g. sintered α-alumina and is of pore size 0.1-20 μm. For water separation from e.g. ethanol or isopropanol the membranes may be of zeolite 4A and may further comprise a surface modifying agent cross-linked with the zeolite to form a membrane with substantially no defects. Conveniently the surface modifying agent is cross-linked silicic acid or an alkyl silicate. Typically, such designs have been developed so as to maximise the surface area per unit length of the monolith, combined with the minimum pressure drop whilst maintaining high overall permeability. The thickness of the walls of the conduits, between conduits and the outside of the ceramic support or monolith will need to be sufficient to give structural strength and be sturdy enough not to break with small knocks and bumps in manufacturing the membrane, placing in the membrane housing and during use, but also be thin enough and porous enough to allow the water permeate to be removed as easily as possible without the pores become water clogged and hindering the performance (high permeability). The ideal wall thickness between conduits is 2 mm and between the conduit and outside of the support is 4 mm. For a tubular membrane, the larger the diameter of the tube the greater the surface area per unit length of the tube, and the lower the pressure drop down the tube. This is normally a desired criterion. However, the larger the diameter of the tube, the greater the possibility at any given flow rate of streamline flow down the tube and the greater the distance from the centre of the tube to the membrane and this will lead to a corresponding loss of performance. On the other hand, a narrower tube gives a lower surface area per unit length, and requires a lower flow rate to give the same degree of turbulence, but gives a higher pressure drop. In order to balance these characteristics, a series of parallel tubes in a module can be used, with the diameter of each tube chosen for optimum performance and the number of tubes chosen to have the desired surface area in the module.

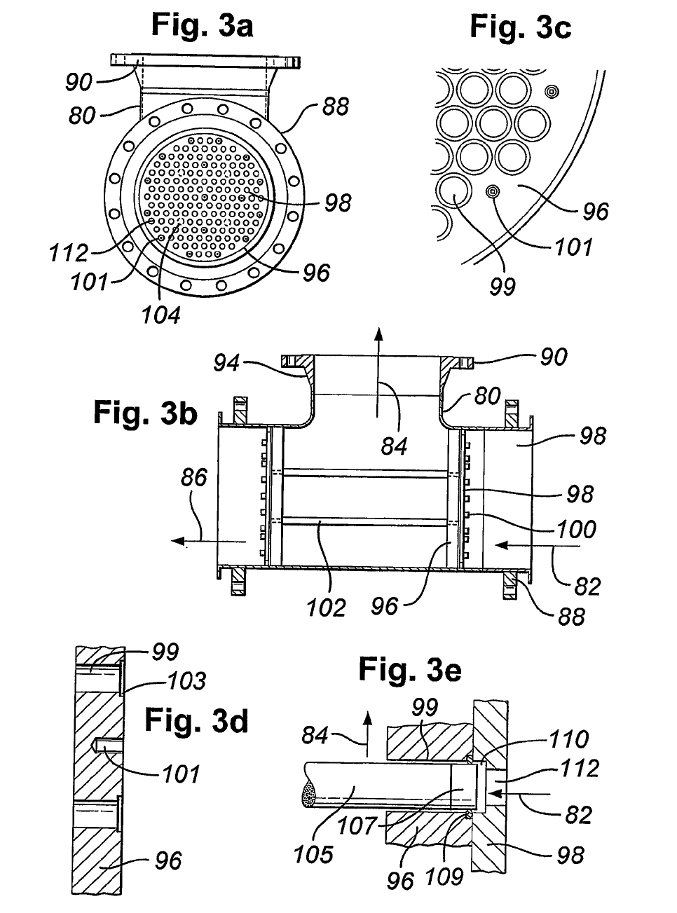

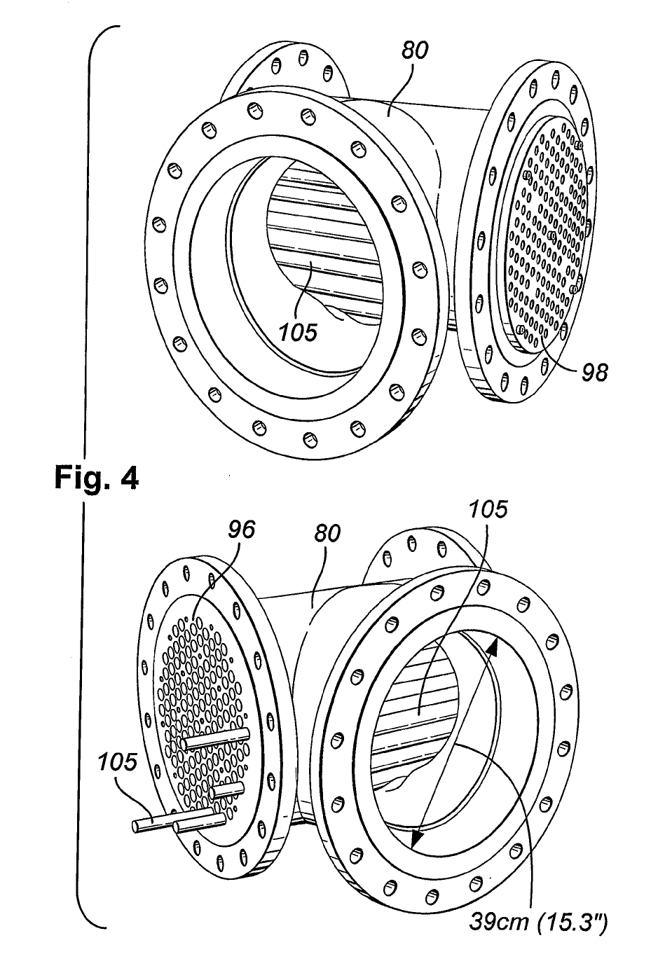

Each monolith according to this later embodiment has significantly greater surface area than the monoliths of WO 00/20105, and therefore the demands as to the number of monoliths required to make up a commercially practical pervaporation module of a specific surface area is reduced. Pervaporation modules are rated according to the area of membrane in the module, a 6 m² membrane area being typical. To achieve this working area of membrane, in the prior art a module (FIGS. 3a-3e and 4) may be of internal diameter about 40 cm and may have 130 supports or monoliths fixed in spaced parallel relationship within its internal volume and extending from end to end of that volume. Increase of the working area of the monolith reduces the number of monoliths required for a module of a given membrane working area, and self-evidently reduces manufacturing costs and parts inventory. Furthermore, the module has a branched tubular housing of stainless steel or other suitable material formed firstly with a through passage and secondly with a branch or cross-flow passage for water or other separated material that has passed through the membranes and through the bodies of the monoliths or supports. For the module to work, each end of the support or monolith has to be sealed to a transverse housing plate or sheet at each end of the through passage. If any of the supports or modules is inadequately sealed, then the module cannot be used because of ethanol, butanol or other material to be treated will by-pass the membranes. Reduction of the number of modules and therefore in the number of seals that have to be made contributes significantly to reliability and ease of manufacture.

The ends of the support or monolith need to be glazed because without the glaze the feed will hit the end of the tube and travel through the ceramic body of the support or monolith without going through the membrane layer in each conduit or channel. The proportion of the feed which travels this route will not be changed in composition in any way and in the case of separation of water from ethanol or other organic liquid, the permeate becomes contaminated with organic material. With the glazed end this cannot happen and all the feed will be treated by the membranes in the conduits or channels so that the permeate is water and the organic component in the feed becomes concentrated. For polymeric membranes as they have poor selectivity this problem has not been apparent before and has not needed to be addressed, but with zeolite membranes as the permeate is pure water down to low feed water concentration this is important as a pure water permeate can be disposed of easily and cost effectively whereas a permeate contaminated with organic liquid will need further costly treatment before disposal.

There is also provided a module comprising a housing having a through flow passage and a cross-flow passage, a multiplicity of the membrane structures as set out above fixed in spaced parallel relationship in the through flow passage, and sealing members effecting a seal at each end between each membrane structure and the housing. The sealing members may be of elastomeric material suitable for the operating temperature e.g. Kalres or Viton which may be PTFE coated and may be in the form of O-rings and may seal against glazed outer surface regions of the support or monolith.

The above membrane structures can be used in pervaporation. In that process water permeates from the feed stream onto, into and finally though the membrane. On exiting the membrane on the permeate side the liquid vaporizes due to the low pressure—hence a combination of the two terms PERMeation and Evaporation gives the process of ‘pervaporation’. Alternatively the membrane structures can be operated with a pure gaseous feed stream (gas or vapor permeation) where the membrane operates in the same manner and gives the same high performance.

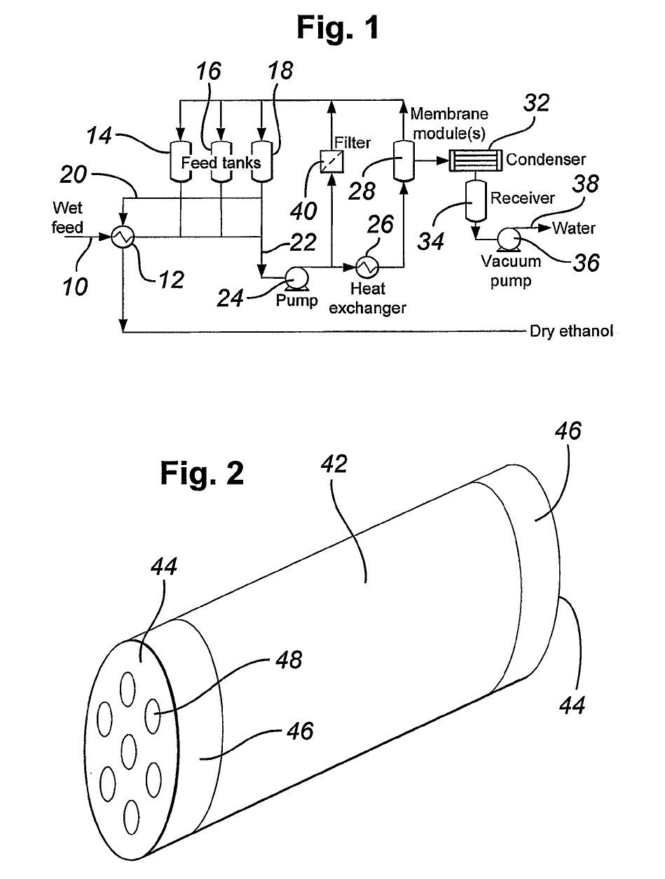

In the embodiment shown in FIG. 1 which shows a multi feed-tank rapid batch system, water-containing organic solvent feed 10 to a pervaporation plant 20 e.g. 5-99% v/v ethanol can arrive either from tankage or direct from upstream processing (e.g. a distillation column) and in the case of ethanol may typically be about 95% v/v ethanol. All membranes have a safe operating pH range in which performance and resistance to feedstocks can be maintained. Automatic control of the pH of the feedstock stream 10 to within that range is preferably provided. Several methods can be used to control pH e.g. ion exchange using an ion exchange resin or an integral in-line pH correction sub-system employing either acids or bases to control pH. Such a pH control system may employ the steps of (a) dilution of in-coming feedstock with water (e.g. permeate), (b) measurement of pH (in-situ), (c) control/metered dosing with a pH correction fluid and/or (d) final monitoring of pH. Furthermore the stream 10 may be pretreated to remove divalent cations which can effect the performance and longevity of zeolite membranes. Appropriate ion-exchange resins can be used to reduce the level of these cations.

This feed stream may be at a temperature from 0 to 50° C. and may be pumped sequentially via heat exchanger 12 into one e.g. 14 of three feed tanks 14, 16, 18. The temperature of the feed stream 10 may be raised by passage through the heat exchanger 12 where it exchanges heat with a hot product stream 20 of dried ethanol or other solvent exiting from another of the feed tanks e.g. 16. Whilst this filling/emptying operation is in progress a hot feed stream 22 from the third tank e.g. 18 is processed through the membrane plant. The feed is then re-circulated by pump 24 under a high cross flow velocity through heat exchanger 26 and membrane module 28 containing membrane tubes or monoliths until the desired water content in the product is obtained. In the membrane module 28, a pervaporation process takes place which is a liquid separation process for the removal of water from ethanol or other solvent based on the selective adsorption-desorption of one chemical species from the feed stream. In this case water is adsorbed onto the zeolite layer and permeates through the membrane and support structure. On the downstream low pressure (vacuum) side of the membrane the water is removed as a cross-flow 30 from the surface/substrate, passes to condenser 32, receiver 34 and thence to vacuum pump 36 which may be of the oil-filled or vacuum type or may be an eductor from which water vapor emerges as an effluent stream at 38. The feed stream is continually depleted in water until the require water content is obtained.

Convention filtration is carried out in what is often described as ‘dead-end’ filtration mode in which all the feedstock flows onto the filter. Liquid then passes through the matrix and solids are left behind. However as the solids concentration rises on the filter a layer of solids becomes deposited on the surface which forms a micro-layer and inhibits further filtration. Hence the rate of filtration slows down and eventually stops. This build up of solids is termed a boundary layer or the surface is said to become polarized (enhanced level of solids). As will be apparent from FIG. 1 the present membranes or monoliths are normally operated in a different processing scenario called cross flow separation. The liquid stream to be processed is passed across the membrane surface parallel to the membrane surface typically at 80-150° C. and at a pressure of 1-15 barg, e.g. about 5-10 barg. The velocity of the feed stream may be controlled at a high rate, 1-6 m/sec, preferably 2-6 m/s. At these velocities fine contaminants stay in the main fluid flow and do not migrate to the membranes surface so that the permeate rate is not reduced with time or reduction in rate is slowed. This mechanism also ensures that as water permeates through the membrane ethanol is not allowed to concentrate on the membrane surface. Use of cross flow velocities in the above range has been demonstrated to improve membrane performance. This liquid velocity refers to the flow rate of the feed stream through the multi-channels of each membrane tube of the monoliths to be described below. This high cross-flow velocity causes a turbulent flow regime with full back mixing and effectively scours the surface of any solids and prevents any tendency for ethanol to concentrate on the membrane surface. Operation in this mode e.g. at a Reynolds number in excess of 3000, e.g. 5000 or higher imparts a high degree of shear at the membrane surface and hence reduces or prevents the phenomenon of surface polarization which prevents membranes from operating to their full potential. Operation under a high cross flow velocity therefore reduces the tendency for the membrane surface to become polarized with solids or ethanol and enables higher operating fluxes to be maintained.

A filter vessel 40 has been included in a side stream of the re-circulation loop to remove and collect any suspended solids present in the process flowlines. The filter unit 40 is desirably of high dirt holding capacity to minimize replacement frequencies The filter unit 40 serves to reduce or prevent carry over of particles into the ethanol or other solvent product stream 20. Any type of solid retaining device manufactured in any material, cartridge type, back-washable or even a cyclonic device can in principle be used.

All membrane processes are basically a filtration process and pervaporation is no different—separation is on a molecular level. Water being of a smaller atomic diameter will easily pass through the membrane structure whilst all other materials will be retained. In a purely binary mixture: e.g. ethanol and water, this presents no problems. However, with the presence of other components, either solids or liquids may accumulate on the process/retentate side of the membranes. Continued processing under these conditions could allow the concentrations of these species to rise and even approach level where they could effect the rate of pervaporation (surface polarization). To prevent this phenomenon developing the feed-stream 40 is continuously processed, again in-situ, using the filter 40 for an in-line separation process e.g. fine filtration to reduce or remove solids which may be normally present solids or those produced during the process of pervaporation.

A pervaporation membrane is highly selective they produce a stream 30, 38 which contains water substantially free of solvent (ethanol) and which can be discharged to the environment without further treatment e.g. it may be >70% v/v water. However towards the end of the dehydration operation ethanol may pass through the membrane and may appear in the effluent stream. Under these condition the permeate 30, 38 may be collected and returned to the apparatus for further processing to ensure that ethanol or other solvent is not discharged to the atmosphere. Thus in the pervaporation operation the process can involve initially segregating the permeate stream until traces of solvent appear. The safe-to-discharge water stream produced during the early stages of pervaporation can then safety be put to waste. Permeate collected in the latter stages that may contains traces of solvent may be collected separately and either re-cycled to the process or discarded in a safe controlled manner.

After treatment, feed from a second feed tank e.g. 16 is automatically switched to the membrane module 28 for processing and the product stream 20 is discharged via heat exchanger 12 against cold incoming feed 10 as previously described.

The use of three feed tank system 14, 26, 18h allows for one tank to be processing whilst the second tank is filling with fresh feed and the third tank is emptying of product. Hence the membrane unit 28 can be continually processing feedstock and no production time need be lost. Furthermore, this format also allows for the heat energy in the third (emptying) tank to be recovered against the fresh in-coming cold feed against feed to the second tank two by employing a high efficiency liquid-liquid heat exchanger 12.

FIG. 2 is a diagrammatic perspective view of a porous monolith 42 having in this instance seven axial conduits 48 opening through opposite end faces 44 of the monolith. Glazed regions 46 cover the end faces 44 and extend partway along at least the outer surface of the monolith as shown to permit fluid-tight O-ring seals to be made to the outer surface of the monolith with a certain amount of end-float to allow for manufacturing tolerances. In this way seals may be made to opposite ends of the monolith 42 so that fluid is forced to flow freely from one end face 44 of the monolith only along the axial conduits 48 to the other end face 44. The extent of cross-flow of fluid through the porous body of the monolith will depend on its porosity, the nature of the fluid and any membranes formed on the cylindrical inner surfaces of the conduits 42.

Four conduit monoliths are of length 1200 mm, diameter 20 mm and conduit internal diameter 6 mm. Glazed end seals extend 15 mm from each end of the monolith and the glazing is smooth with complete glaze coverage. Seven and 19-conduit monoliths are of length 600 mm or 1200 mm and conduit internal diameter also 6 mm. The conduits of the monolith must be at least 5 mm in diameter otherwise not enough hydrogel zeolite growth solution can be got into the conduit to form the membrane in one growth due to the viscosity of the growth solution (like wallpaper paste). A uniform zeolite membrane will only form in circular type conduits. Anything with sharp edges hinders uniform membrane formation. In contrast, solution prepared in relation to the high pH solution technique is not viscous and will go down narrower conduits but as it contains a smaller quantity of reactants to form a membrane in one growth.

The membranes or supports 105 (FIG. 3e) are incorporated into a treatment module which comprises a T-shaped tubular housing of stainless steel or other suitable material generally indicated by the reference numeral 80 which has a through-flow path for fluid to be treated indicated by arrows 82, 86 and a cross-flow path 84 for gas separated by pervaporation or gas permeation. Flanges 88, 90 provided with fixing holes enable the module to be attached by bolts to adjoining pipework. Fitted into the main flow path is a membrane or support holder comprising a pair of membrane support plates 96 welded or otherwise fluid-tightly attached to the inner surface of housing 80 and held at the appropriate spacing by four spacer bars 102 with threaded ends that are screwed into fixing holes 104 (FIG. 3a) in the plates 96. The plates 96 are configured to support a multiplicity of the membrane structures 105 fixed in spaced parallel relationship in the through flow passage, for which purpose they are formed with a multiplicity of membrane structure receiving holes 99 disposed in an array. Where the holes 99 open to the outer face of the plates 96 they are formed with radially enlarged regions 103 for receiving O-ring seals 109 e.g. of Kalres or Viton which may be PTFE coated. As in apparent in FIG. 3e, the ends of the supports or monoliths 105 have glazed end regions 107 which protrude slightly beyond the outer faces of the plates 96 and which are fluid-tightly sealed by the O-ring seals 109. In this way, fluid entering the module at 82 has to pass along the internal channels in the modules 105 to the downstream side as indicated by arrow 86 and cannot pass unseparated to the cross-flow path 84. When the modules are in place, cover plates 98 formed with through-holes 112 corresponding to each module position are attached to the support plates 96 by means of bolts 98 received in threaded holes 101. The holes 112 in the cover plates 98 open to the blind faces via radially enlarged rebated regions 110 that receive the ends of the supports or monoliths 105. It will be seen that the supports or monoliths only directly contact the O-ring seals 109 and do not touch either the holes 99 in plates 96 or the cover plates 98. The supports or monoliths are effectively floating without metal-ceramic contact, and differences in coefficient of thermal expansion between the ceramic of the monoliths or supports and the stainless steel or other material of the housing 80 and other metallic components do not give rise to problems.

It will be apparent that the module is mechanically complex because of the large number of monoliths 105 in the array to give the required membrane surface area, and the large number of seals at O-rings 109. Failure to form a fully effective seal at an end of any of the modules 105 results in un-separated fluid at 82 entering the cross-flow path 84, and if this happens it is difficult and time-consuming to identify which monolith or monoliths have defective seals. The seals to each monolith are subject to severe conditions because of the pressure difference in the through-flow direction i.e. through the passages in the monoliths which is typically at 5-10 barg and the cross-flow direction which is at or near vacuum. For that reason, any reduction in the number of monoliths required, as by increasing the internal membrane area of each monolith, has significant practical advantages over and above those of decreasing the required diameter of the housing 80.

It is particularly important that the plates 96 should not be distorted because any deviation from planarity will create differences between the pressure exerted by the cover plates 98 on the O-ring seals 109 in different parts of the module and may affect the sealing. To withstand the pressure differential reliably and also to cater for manufacturing tolerances, especially in the ceramic of monoliths 105, a high degree of compression of the O-rings is required so that they assume a somewhat rectangular shape as shown. Lack of flatness may mean that the required compression is not achieved everywhere. In order to avoid this phenomenon, the plates 96 are supplied drilled with pilot holes only and are welded in situ, after which the outer faces are machined flat. Then the receiving holes are drilled to the required diameter, and radially enlarged regions 103 for receiving the O-rings are machined. To facilitate machining after welding into position, the plates 96 may be relocated from the position shown in FIG. 3b to coincide with the ends of the housing 80 as shown in FIG. 4 (the upper view shows a cover plate in position, and in the lower view the cover plate is removed).

In general membrane modules can be prepared containing from 1 to 250 off membrane tubes and all may be prepared in the following manner
(a) major components are fabricated:
   (1) off body sections—normally a standard T piece coupling
   (2) off tube sheets
(b) tube sheets are pre-drilled with pilot holes only for enlarging latter to take the membrane tubes
(c) tube sheets are welded to the body section.
(d) outside faces of tube sheets are machined flat—precision engineering job
(e) tube sheet are drilled to exact dimensions for clearance holes to take membrane tubes and recessed holes to form O-ring seats.

If, contrary to the above procedure, machining is performed before welding then distortion of the tubes sheets or support plates occurs and is more difficult/impossible to remedy, sometime necessitating the re-manufacture of the whole vessel. A similar situation occurs with the matching of the cover plate which needs to be accurately machined to ensure a tight seal. The O-rings used need not only to be chemically compatible with the process fluid—in this case ethanol at the final, product concentration of e.g. 99.8% at 130° C. but should be of an appropriate hardness—too hard and they can shatter the membrane tubes. Adequate clearance needs to be allowed for when machining the sealing journals to allow for the differential expansion of the ceramic membrane tubes and the metallic housing, which is important when operating at relatively high temperatures e.g. 130° C.

During their life the membranes will get fouled from dirty feeds. The membranes can be periodically cleaned by washing with the solvent being dried and deionised water (Cleaning Water/Solvent Washing 90:10). The solvent/deionised water combination must always have at least 10% solvent otherwise the deionised water will remove sodium ions from the membrane and lead to a loss in performance because of a deterioration of the zeolite 4A structure and ultimately to membrane failure through cracking due to increased internal strains within the zeolite crystal lattice. In practice to overcome loss in performance either from the above or due to ageing of the membrane, plants are oversized by 10 to 20% to allow for this and to ensure the plant will do the duty for the life of the membranes (1 to 3 years depending on the mature of the feed).

During in life use, especially with high water containing feeds sodium ions will be leached out from the zeolite structure, as described above. Therefore, to overcome this and to extend the life of the membrane, the membranes can be washed with a 90:10 solvent:deionised water mixture containing a small percentage of sodium ions (up to 1%). The sodium ions should come from a soft and not a hard base source e.g. sodium acetate and not sodium chloride.

In a representative pervaporation procedure e.g. for drying ethanol or butanol using the present monoliths there may be used a temperature of about 130° C. for high water flux through the zeolite membrane and a pressure of about 8 bar to maintain liquid phase throughout membrane processing. The flow rate of the feed along the conduits may be about 4 metres/sec to reduce or prevent concentration polarization at the membrane surface, hence increasing water flux rate. At the outside of the monoliths there is applied a vacuum of 20-100 millibar for vaporizing and removal of water permeate, hence increasing water flux rate.

It will be apparent that various modifications may be made to the embodiments herein without departing from the invention. As previously explained, in embodiments, solutions of water in organic solvents e.g. ethanol can be dried and concentrated down from any water level to below 0.1% water and azeotropes are easily broken. Liquids that can be treated include, but are not limited to, alcohols such as ethanol or butanol, ketones, ethers e.g. THF or diethyl either, amines, DMF, mineral oils e.g. transformer oil, oils of biological origin e.g. corn oil and other seed derived oils, essential oils, agrochemicals, cleaners and detergents, flavours and fragrances, inks and adhesives, cosmetics and toiletries, paints and dyes and equilibrium reactions systems e.g. in which removal of water promotes reaction. High temperature resistance of the this membrane enables its use at higher temperatures yielding higher permeate fluxes and reduced membrane area or shorter drying times. As previously stated, due to the high membrane selectivity, the permeate produced consists of high purity water which can be recycled or discharged without further treatment.

1-28. (canceled)

29. A method for separating water from an organic solvent which comprises:
passing the solvent through at least one conduit within a porous ceramic with a zeolite membrane formed on the internal surface of the conduit;
recovering solvent of reduced water content from the conduit; and
recovering water which has passed via the membrane through the ceramic to the exterior thereof;
wherein the velocity at which the solvent is passed through the conduit induces turbulent flow for scouring contaminants from the surface of the membrane and/or reducing or preventing concentration of the organic solvent on the membrane surface.

30. The method of claim 29, which comprises passing the solvent in parallel through a plurality of conduits formed in a ceramic monolith.

31. The method of claim 29, wherein the conduit or conduits have any of the following features:
(a) internal diameter of 5 to 9 mm e.g. 6.4 mm;
(b) the ceramic is sintered α-alumina;
(c) the membrane is of zeolite 4A;
(d) the membrane further comprises a surface modifying agent cross-linked with the zeolite to form a membrane with substantially no defects;
(e) the surface modifying agent is cross-linked silicic acid or an alkyl silicate.

32. The method of claim 29, wherein
(a) the velocity of the solvent is 1-6 m/s;
(b) the velocity of the solvent is 2-6 m/s; and/or
(c) the solvent is ethanol.

33. The method of claim 29, wherein the solvent is passed through the conduit at 80-150° C. and at a pressure of 1-15 barg.

34. A method for separating water from an organic solvent which comprises:
passing the solvent through at least one conduit within a porous ceramic with a zeolite membrane formed on the internal surface of the conduit;
recovering solvent of reduced water content from the conduit; and
recovering water which has passed via the membrane through the ceramic to the exterior thereof;
wherein the conduit or conduits is or are of internal diameter of 5 to 9 mm and the velocity at which the solvent is passed through the conduit or conduits is 1-6 m/s.

35. A method for separating water from an organic solvent which comprises:
supplying the solvent to first, second and third tanks;
circulating solvent between the first tank and zeolite membranes to separate water therefrom;
recovering separated water from the membranes;
supplying fresh solvent to the second tank;
recovering solvent separated of water from the third tank in heat-exchange relationship with solvent supplied to the second tank; and
on completion of water separation initiating at least a first new processing cycle in which recovery is from the first tank, circulation is from the second tank and supply is to the third tank.

36. The method of claim 35, having any of the following features
(a) on completion of said first new processing cycle at least a second cycle is initiated in which supply is to the first tank, recovery is from the second tank and circulation is from the third tank;
(b) recovery of water is to a region of reduced pressure;
(c) the solvent is circulated at 80-150° C. and at a pressure of 1-15 barg;
(d) the circulation step includes passing at least part of the circulating stream through a filter for removing suspended solids;
(e) the circulating solvent is passed through at least one tubular porous ceramic monolith having conduits formed within the monolith with a zeolite membrane formed on the internal surface of the conduits;
(f) ceramic monolith is sintered α-alumina;
(g) the membrane is zeolite 4A;
(h) the solvent is ethanol or isopropanol.

37. Apparatus for separating water from an organic solvent which comprises:
a solvent supply line;
first, second and third tanks;
a membrane module containing zeolite membranes for effecting separation of water from the organic solvent;
a pump and lines for circulating solvent from one of the tanks under pressure through the membrane module;
a line at reduced pressure for recovering separated water from the membrane module;
valve means for switching each of the tanks between receiving, circulation and emptying modes; and
a heat exchanger for exchanging heat between solvent entering one of the tanks and treated solvent being drained from another of the tanks.

38. Apparatus for separating first and second fluids, comprising:
a multiplicity of tubular porous ceramic monoliths having tubular conduits formed within the monolith with a zeolite membrane formed on the internal surface of each of the conduits;
first and second support plates each formed with a multiplicity of holes for receiving the ends of the monoliths for supporting said monoliths in spaced parallel relationship, the holes where they open to outer faces of the support plates being formed with counterbores;
O-rings in the counterbores for supporting the monoliths in the apertures each at a small clearance from its respective hole;
first and second cover plates attached to the first and second support plates and formed with holes corresponding to the holes in the support plate leading to enlarged inwardly facing regions in which ends of the monoliths are received, attachment of the cover plate compressing the O-rings to seal against the monolith; and
a housing having a flow passage in which the first and second support plates are welded;
wherein the support plates have outer surfaces machined flat after the support plates have been welded in position.

39. The apparatus of claim 38, wherein the housing is generally T-shaped to define a through-flow path and a cross-flow path.

40. The apparatus of claim 38, wherein the outer surfaces of the support plates substantially coincide with the ends of the housing.

41. A method for separating water from an organic liquid which comprises:
passing the liquid through at least one conduit within a porous ceramic with a zeolite membrane formed on the internal surface of the conduit;
recovering liquid of reduced water content from the conduit; and
recovering water which has passed via the membrane through the ceramic to the exterior thereof;
wherein the velocity at which the liquid is passed through the conduit induces turbulent flow for scouring contaminants from the surface of the membrane and/or reducing or preventing concentration of the organic solvent on the membrane surface.

42. The method of claim 41, wherein the velocity at which the liquid is passed through the conduit induces flow at a Reynolds number in excess of 3000.

43. The method of claim 41, wherein the velocity at which the liquid is passed through the conduit induces flow at a Reynolds number of 5000 or above.
